(19) United States
(12) Patent Application Publication
(10) Pub. No.: US 2005/0018908 A1
(43) Pub. Date: Jan. 27, 2005

(54) Method for compressing digital images to a predetermined size by calculating an optimal quality factor

(76) Inventors: Anders Johannesson, Hollyiken (SE); Ingemar Larsson, Malmo (SE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/495,351

(22) PCT Filed: Nov. 6, 2002
(86) PCT No.: PCT/SE02/02011

(30) Foreign Application Priority Data
Nov. 13, 2001 (SE) 0103746-4

(51) Int. Cl. G06K 9/36

(52) U.S. Cl. 382/232

(57) ABSTRACT

A method for compressing a digital image composed of a matrix of pixels to provide a compressed digital representation of said image of a predetermined size, the quality of the compressed digital representation being affected by a compression quality factor Q and the method including the fol-lowing steps: for a particular image producing device, developing a mathematical model defining a relationship between the content of the digital image and Q, developing said mathematical model by repeatedly compressing a set of digital test images with varying Q until each test image is compressed to a predetermined size, determining a metric M representing the content of the digital image, applying said metric M in said mathematical model to obtain an image determined quality factor Qmod and compressing the digital image using said quality factor Qmod.

### BACKGROUND OF THE INVENTION

The invention relates generally to a method for compressing digital image data, and more particularly to a method for compressing digital image data to a predetermined size.

A standard commonly used for compressing digital images is JPEG, which is a standard sanctioned by the ISO (International Standards Organization). After compression the image has little or no noticeable quality degradation.

Most common JPEG-compression uses a lossy compression algorithm to reduce the amount of memory needed to store the images. This means that a decompression algorithm cannot fully reconstruct the original images. The differences are, however, normally very small and in most cases not possible to see when the images are viewed on a screen or printed on paper.

JPEG-compression is based on image transforms that are calculated in 8×8 pixels windows. Most of the compression is achieved by manipulating the coefficients of these transforms so that they require less memory to store. This manipulation may be quantized in a parameter called the compression quality factor Q. This factor is one of the parameters that can be set before compression is performed.

The quality factor Q doesn't say much about which compression ratio that will actually be achieved for a particular image. Instead the compression ratio depends strongly on the image content.

In an application, like a digital camera, where a fixed memory slot may be available per image, it is of great importance to know that all images will fit this slot. It is thus desirable to know the quality factor Q that is needed to achieve this goal. An optimal Q can be found if the image is allowed to pass the compression algorithm several times with different Q values. However, such a scheme normally is too time and memory consuming.

In a digital camera a solid state or semiconductor sensor normally is used to pick up an image. The sensor is a grid of light-sensitive cells representing pixels. The pixel cell sensors are essentially monochromatic and respond primarily to the intensity of the light falling on them, regardless of the colour of the light. They can be made sensitive to different colours, by placing a filter over each pixel during manufacturing. In a RGB colour sensor each given pixel location either has a red, a green or a blue filter.

As the human eye is more sensitive to green light than to red or blue more pixels are devoted to green. Normally, a pattern is chosen where every second pixel in every line and every row is a green one. Every second row contains intermediate red pixels and every second row contains intermediate blue pixels besides the green pixels. Such a pattern is called a Bayer pattern.

### PRIOR ART

There are several methods of calculating the quality factor Q. One method is disclosed in U.S. Pat. No. 5,677,689 and is a fully JPEG compliant two-pass approach that can compress an arbitrary image to a predetermined fixed-size buffer. According to the method disclosed in U.S. Pat. No. 5,677,689 computation of the inverse DCT coefficients is eliminated during the second pass. During a first pass the original image is compressed with the JPEG algorithm using a predetermined Q-factor value Qᵢₙᵢₜ. The first pass includes all the processes of a standard JPEG processing block including the DCT coefficient process, a quantizing process, and a variable length coding (VLC) process resulting in an output of a JPEG compressed image with a Q-factor of Qᵢₙᵢₜ.

U.S. Pat. No. 6,118,903 discloses an alternative method for compressing a digital image according to which transform coefficients of an energy-packing transform are quantised by using a selected quantisation table. The number of zero-value quantised transform coefficients and a predetermined bit budget are used to select a quantisation table to quantise the coefficients of each transform and then compressing the coefficients using runlength-encoding (RLE).

These methods all rely on the compression algorithm somehow and require a substantial amount of extra processing that is time consuming. The calculation steps also increase the memory demands of the required circuitry. A method is needed which in preparatory and reliable steps facilitates a JPEG compression of a digital image.

### SUMMARY OF THE INVENTION

The present method is a two-step method for compressing a digital image where a second step can be a conventional JPEG encoding. The method does not rely on the compression algorithm, but on a quantity that can easily be calculated directly from the image. It works also directly on a Bayer pattern image. A calibration step is needed where the relationship between the required Q-factor and the quantity is determined for the target compression ratio. The calibration step is based on a set of typical images and is done once.

The quantity used to estimate the image content, called the metric M below, is defined by the following formula (1):

$$M = {\sum }_{i = 1}^{n} {\sum }_{j = 1}^{m} ( \vert {I}_{i , j} - {I}_{i + 2 , j} \vert + \vert {I}_{i , j} - {I}_{i , j + 2} \vert ) \qquad ( 1 )$$

where n and m are determined by the size of the matrix, and I(i, j) is the intensity of the (i, j)th pixel in said matrix.

The intensity I can be approximated by the intensity in the green channel of a R,G,B colour image or the subset of green-sensitive pixels in a Bayer image. This has been experimentally confirmed. It is further supported by the definition of Luminance in JPEG-compression standard, which has a higher weight for the green component than for the other two colours and by the definition of the Bayer-pattern. The metric is an estimation of the total gradient content in the image at a relatively high frequency.

If the image to be compressed is derived from a Bayer-image it is desirable to operate directly on the Bayer-pattern. There are several advantages; The number of calculations needed is significantly reduced (which may reduce memory requirement and increase speed further). No processing is needed to extract the ‘true’ image before the metric is calculated. If the metric is calculated from raw Bayer images and if it is combined with processed images during the calibration, the quality of the model depends on the nature of the processing (interpolation, color corrections, sharpening etc).

### BRIEF DESCRIPTION OF THE DRAWINGS

A further understanding of the features and advantages of the present invention may be realized with reference to the description below and to the accompanying drawings, in which

FIG. 1 is a flow chart showing steps for establishing a mathematical model describing the relationship between a metric M of the image and a compression quality factor Q,

FIG. 2 is a set of two plots (with fitted models) showing the relationship between M and Q for a set of colour VGA images that are compressed to 1/20 of their original sizes, and

FIG. 3 is a flow chart showing use of the mathematical model in a method according to the invention.

### DETAILED DESCRIPTION

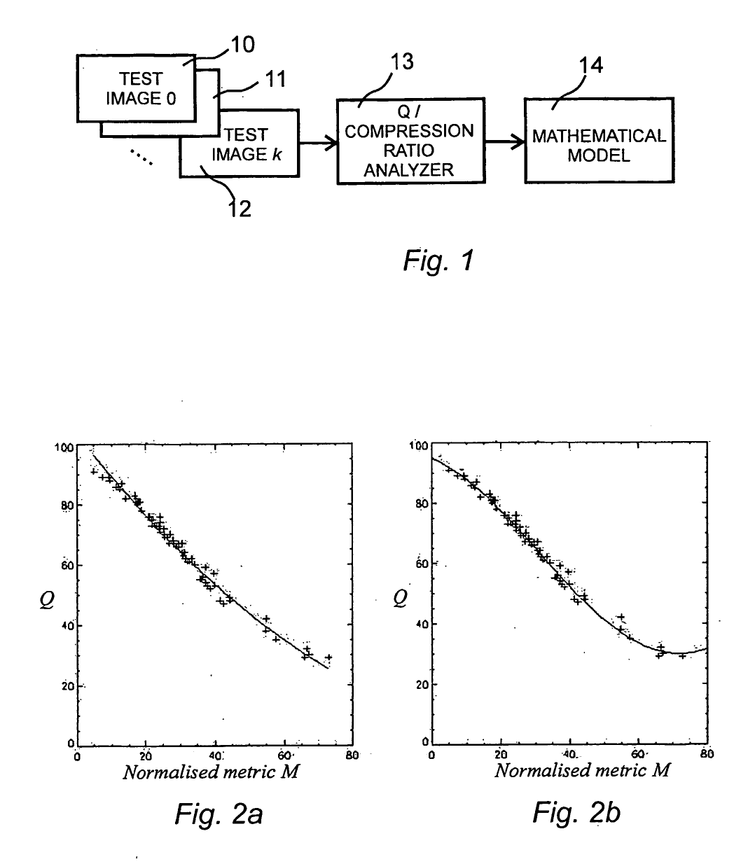

FIG. 1 shows in a diagram suitable steps for establishing a mathematical model describing the relationship between a metric M of the image and a compression quality factor Q. When the method has been established it is possible to choose an appropriate quality factor Q after determining the metric M of the image chosen to be compressed. The relationship depends on the desired compression ratio, the size of the image (if no normalisation is used) and on the image source (the sensor and lens) that may have certain characteristics. Preferably a plurality of images should be used. In FIG. 1 test images 10, 11 and 12 are referred to as image 0 to image k. Each test image is sent to a Q/Compression ratio analyser 13. The Q/Compression ratio analyser 13 will produce a mathematical model 14.

The basis for establishing the mathematical model is a representative set of calibration digital images, acquired by a specific device, i.e. a sensor or a camera. The calibration images should not be compressed by a lossy compression technique before they are used. The steps for establishing the mathematical model correspond to a calibration of the device using calibration images.

For each calibration image the metric M of the image is determined and saved. A plurality of conventional JPEG compressions are performed with different quality factors Q until the predetermined compression factor is obtained. The one compression resulting in the target compression ratio (i.e. 1:20) gives the appropriate Q value, Q_{mod}.

A test was made with 79 images and turned out to provide an adequate result. The relationship between the metric and the “appropriate” Q factor was fitted with a function (in this example to a polynomial and a trigonometric function), forming the mathematical model. The polynomial function can be of any order.

FIG. 2a and FIG. 2b show the relation between a normalised metric M and Q in a set of 24-bit color VGA images (640×480 pixels) for a compression target of 6 1/20. M here is calculated utilizing only the green image plane and is normalized with the total number of pixels used. The diagrams in FIG. 2a and FIG. 2b show two different functions fitted to the data, a 2:nd degree polynomial (FIG. 2a) and a trigonometric function (FIG. 2b). The coefficients of the fits in this example are:

Polynomial fit:
Used function: Q(M)=a+bM+cM² (chosen from the more general function: Q_{mod}(M)=k₀+k₁M . . . +kₙM″)
a=103, b=−1.46, c=5.35*10⁻³

Trigonometric fit:
Used function: Q(M)=a cos(2πM/b+c)+d
a=33.6, b=164, c=0.38, d=63.6

After completion of the calibration step the coefficients of the mathematical model are determined. Each new image is then dealt with as in the calibration step to determine the image associated metric M. Then the mathematical model that resulted from the calibration step is used to estimate the ‘needed’ Q-factor for the new image.

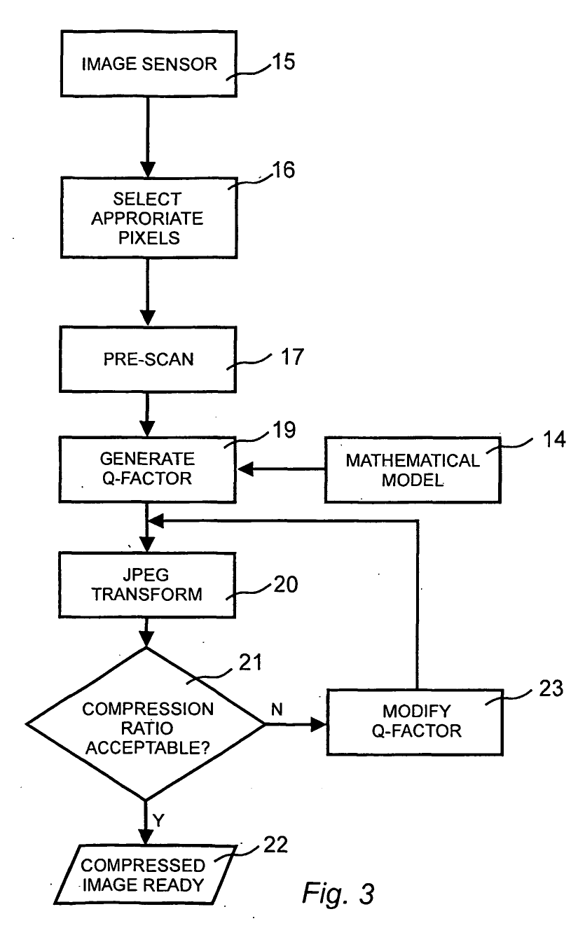

The diagram in FIG. 3 illustrates the process for determining the required Q value and producing a compressed image. In a first block 15 an image is recorded Appropriate pixels are selected in a second block 16 for further calculations and the metric M for the image is determined in a Pre Scan block 17.

The Q factor is then generated in a Q factor generating block 19 using the mathematical model 14 determined before. The resulting Q factor is used by the compression algorithm to compress the image in a JPEG transforming block 20. During or after JPEG transforming it is checked in a second check block 21 whether the target ratio for the compression is met. If the compression ratio is sufficient the compressed image is ready as shown in a third block 22.

If the compression ratio is not acceptable the Q-factor is modified in a fourth block 23 and a further compression is done in the JPEG transforming block 20. The modification of the Q-factor that is done in the fourth block 23 normally will result in a lower Q-factor. The latter is a way to handle the low percentage of the images not compressed to the correct ratio.

The images subject to a second compression run are generally not ‘normal’ images. That is they are frequently one-color surfaces, small bright objects on dark backgrounds, images with amplified blue channel due to white balancing or very noisy images. To assure that they are compressed enough the second time it is necessary to use a lower Q-factor.

If an image does not pass the second compression it is suggested that either a third compression is performed or that the application handles this as an error. The only image that has been observed not passing the second test is an artificial image containing very high amplitude random noise (different in the different color channels).

The following technique can be used to generate a second Q-factor, should the first one fail to reach the compression goal. First assume that a typical relationship between compression ratio R and the quality factor Q can be found from the set of test images. The R-Q relation for an image usually has a fairly typical linear part for high Q-values that could be used. If the desired increase of compression is f, the new Q-factor Qs is found from:

$$Qs = fQ + \frac{{k}_{2}}{{k}_{1}} ( f - 1 )$$

where k₁ and k₂ are the coefficients of a fit to the linear part of the R-Q relation for a typical image in the calibration set
R=k₁Q+k₂

The method is sensitive to the quality of the fit. If the model is overestimating the Q-factor at low metric levels it is possible to include an upper limit for the Q-factor. The level of the upper limit can be selected after inspection of the calibration data. The latter is illustrated in FIG. 2 showing the same data set fitted with two different functions.

It has been shown that a simple metric, or gradient factor, may be used to estimate the Q-factor prior to JPEG compression. To work in a real application it is preferably combined with a mechanism for recompression that takes care of rare cases when the metric fails. An upper limit for the Q-factor will eliminate overestimation of the Q-factor for images requiring only slight compression.

1. A method for compressing a digital image composed of a matrix of pixels to provide a compressed digital representation of said image of a predetermined size, the quality of the compressed digital representation being affected by a compression quality factor Q and the method including the following steps:
for a particular image producing device, developing a mathematical model defining a relationship between the content of the digital image and Q,
characterised by
developing said mathematical model by repeatedly compressing a set of digital test images with varying Q until each test image is compressed to a predetermined size,
determining a metric M representing the content of the digital image,
applying said metric M in said mathematical model to obtain an image determined quality factor Qmod and
compressing the digital image using said quality factor Qmod.

2. A method according to claim 1, wherein the metric M is calculated with the formula:
$$M = {\sum }_{i = 1}^{n} {\sum }_{j = 1}^{m} ( \vert {I}_{i , j} - {I}_{i + 2 , j} \vert + \vert {I}_{i , j} - {I}_{i , j + 2} \vert )$$
where n and m are determined by the size of the matrix, and I(i, j) is the intensity of the (i, j)th pixel in said matrix.

3. A method according to claim 2, wherein the intensity I is approximated by the intensity in the green channel of a R,G,B color image

4. A method according to claim 2, wherein the intensity I is approximated by the subset of green-sensitive pixels in a Bayer image.

5. A method according to claim 1, wherein said mathematical model is a polynomial that can be expressed in the form Q_{mod}(M)=k₀+k₁M . . . +kₙM″, the coefficients being determined by said set of digital test images.

6. A method according to claim 1, wherein said mathematical model is a trigonometric function that can be expressed in the form Q_{mod}=a cos(2πM/b+c)+d, the coefficients being determined by said set of digital test images.

7. A method according to claim 1, wherein an upper limit for Q_{mod} is set to a fixed value.

8. A method according to claim 7, wherein an upper limit for Q_{mod} is set to 90.

9. A method according to claim 1, wherein the size of the compressed digital representation is checked to be lower than or equal to a predetermined size.

10. A method according to claim 9, wherein a second compression is performed with a quality factor Q_{second}, where Q_{second} is derived from Q_{mod}.

11. A method according to claim 9, wherein a second compression is performed with a quality factor Q_{second} being a fraction of Q_{mod}.

12. A method according to claim 10, wherein a second compression is performed with a quality factor Q_{second}=1/3*Q_{mod}.
